(19) United States
(12) Patent Application Publication
(10) Pub. No.: US 2025/0353310 A1
(43) Pub. Date: Nov. 20, 2025

(54) INK SUPPLY CONTAINER AND METHOD FOR REMANUFACTURING SAME

(71) Applicant: CANON KABUSHIKI KAISHA, Tokyo (JP)

(72) Inventor: KAZUHIKO EJIMA, Kanagawa (JP)

(21) Appl. No.: 19/197,023

(22) Filed: May 2, 2025

(30) Foreign Application Priority Data
May 14, 2024 (JP) 2024-078955

(51) Int. Cl. B41J 2/175; B01D 29/01; B01D 29/56; B41J 29/00

(52) U.S. Cl. CPC B41J 2/17563; B01D 29/01; B01D 29/56; B41J 29/00

(57) ABSTRACT

The present disclosure includes an ink bag having a spout, a container body that accommodates the ink bag, and a nozzle attachable to and detachable from the container body, which has an ink flow path communicating with the spout while being attached to the container body and an opening portion for opening the ink flow path to the outside, the ink flow path is provided with a filter member that can capture foreign matter contained in the ink flowing in from the spout. This can promote reuse of the container body, and the technologies described in this specification have the potential to contribute to the achievement of a sustainable society, such as a decarbonized society/circular society.

### BACKGROUND

### Field of the Technology

The present disclosure relates to an ink supply container and a method of remanufacturing the same.

### Description of the Related Art

In inkjet printers that perform recording on a recording medium by discharging ink from a head for discharging the ink to the recording medium such as paper, there are ones that can supply ink from an ink supply container to an ink tank of a device body. In recent years, in order to realize a sustainable society such as a decarbonized society/circular society, techniques for realizing reuse for repeated use of used products and their components, recycling for effective use of waste or the like as raw materials and energy sources, and reduction for reducing an amount of waste have been required. For example, Japanese Patent Application Laid-open No. 2022-13034 describes a technique for reducing a volume of a discarded member by easily recycling a part of a used ink supply container. The ink supply container of Japanese Patent Application Laid-open No. 2022-13034 is configured such that an ink bag formed by overlapping a first ink bag and a second ink bag made of a flexible material is accommodated in a container body, and after the ink contained in the inner first ink bag is used up, the first ink bag can be separated from the second ink bag. Then, the remaining container body and the second ink bag can be reused.

In the ink supply container of Japanese Patent Application Laid-open No. 2022-13034, when the first ink bag is separated from the ink supply container, foreign matter may enter the inside of the second ink bag. Also, foreign matter may enter the second ink bag in a process of filling the second ink bag with the ink. In addition, the ink bag is made of a flexible material, and thus when the ink bag becomes broken inside the ink supply container, fragments thereof may become foreign matter in the ink bag.

If foreign matter is present in the ink bag, the foreign matter may enter an ink tank of an inkjet printer together with the ink when the ink is supplied from the ink supply container to the ink tank. If the foreign matter flows into a head, it may clog an ink discharge port of the head, hindering discharge of the ink from the head. Further, the foreign matter may clog a nozzle for injecting the ink from the ink supply container, hindering the ink from being injected from the ink supply container.

### SUMMARY

The present disclosure is directed to the technology to inhibit occurrence of clogging of a head of a printer that has been supplied with ink from an ink supply container or a nozzle of the ink supply container even when foreign matter enters an inside of an ink bag of the ink supply container, thereby facilitating reuse of the ink supply container.

An ink supply container of the present disclosure for supplying ink to a recording apparatus that performs recording by discharging the ink to a recording medium includes the following:
a bag-shaped ink storing member configured to be able to store the ink, the ink storing member including a spout through which the stored ink is injectable;
a container body configured to be able to accommodate the ink storing member in a state in which the ink is injectable from the spout; and
a nozzle configured to be attachable to and detachable from the container body, the nozzle including an ink flow path that communicates with the spout in a state of being attached to the container body, and an opening portion that opens the ink flow path to the outside,
wherein the ink flow path is provided with a filter member configured to be able to capture foreign matter contained in the ink flowing in from the spout.

Features of the present disclosure will become apparent from the following description of embodiments with reference to the attached drawings. The following description of embodiments are described by way of example.

### BRIEF DESCRIPTION OF THE DRAWINGS

FIG. 1 is an external perspective view showing an inkjet printer according to an embodiment.

FIG. 2 is a perspective view showing an internal configuration of the inkjet printer according to the embodiment.

FIG. 3 is a schematic diagram showing an ink supply system of the inkjet printer according to the embodiment.

FIG. 4 is a diagram showing a state in which ink is supplied from an ink supply container to an ink tank according to the embodiment.

FIG. 5 is a front view of the ink supply container according to the embodiment.

FIG. 6 is a cross-sectional view of the ink supply container according to the embodiment.

FIG. 7 is an enlarged view of a nozzle portion of the ink supply container according to the embodiment.

FIG. 8 is a diagram showing a state in which the ink is supplied from the ink supply container to the ink tank according to the embodiment.

FIGS. 9A and 9B are diagrams showing a detailed configuration of an ink supply container according to an embodiment.

FIGS. 10A to 10C are diagrams showing a sealing portion of the ink supply container according to the embodiment.

FIG. 11 is a perspective view of the ink tank of the inkjet printer according to the embodiment.

FIG. 12 is a diagram showing a filter according to Example 1

FIGS. 13A and 13B are diagrams showing a filter according to Example 2.

FIGS. 14A and 14B are diagrams showing a filter according to Example 3.

FIG. 15 is a diagram showing a filter according to Example 4.

FIGS. 16A and 16B are diagrams showing a filter according to Example 5.

### DESCRIPTION OF THE EMBODIMENTS

Embodiments of an ink supply container of the present disclosure will be described. However, components described in the embodiments are merely examples and are not intended as limiting the scope of the present disclosure. In the present specification, “ink” is used as a generic term for liquids such as a recording liquid.

### Embodiment 1

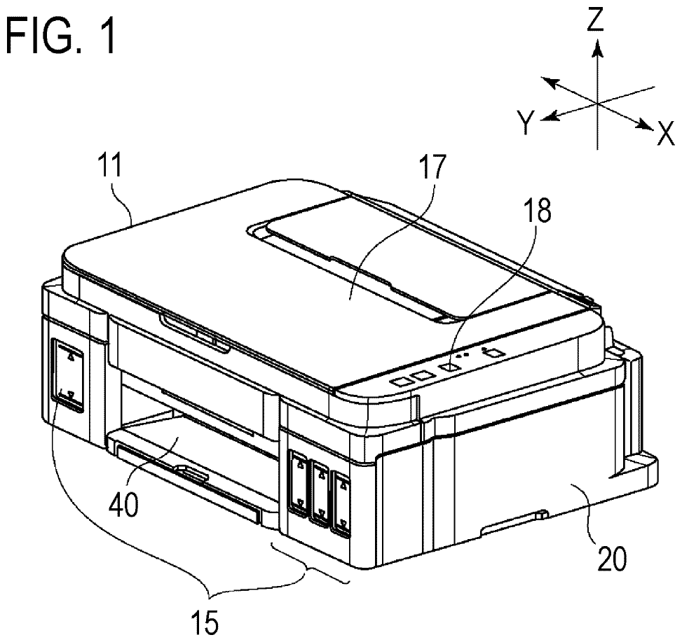

FIG. 1 is an external perspective view showing an outline of an inkjet printer 11 according to the present embodiment. The inkjet printer 11 of the present embodiment is a recording apparatus that records an image on a recording medium by discharging a liquid ink from a liquid discharge head (hereinafter referred to as a head) to the recording medium, and is an example of a liquid discharge apparatus that discharges a liquid. The present embodiment will be described by taking the inkjet printer as an example, but the liquid discharge apparatus of the present disclosure is not limited to the inkjet printer as long as it has a configuration in which a liquid can be supplied from a liquid supply container to a liquid tank of a device body. In the following description, a width direction of the inkjet printer 11 is an X direction, a front to rear direction thereof is a Y direction, and a direction perpendicular to the X and Y directions is a Z direction. When the inkjet printer 11 is installed on a horizontal plane, the Z direction is parallel to a vertical direction. As will be described later, a main scanning direction of the head is parallel to the X direction, and a conveying direction of the recording medium is parallel to the Y direction.

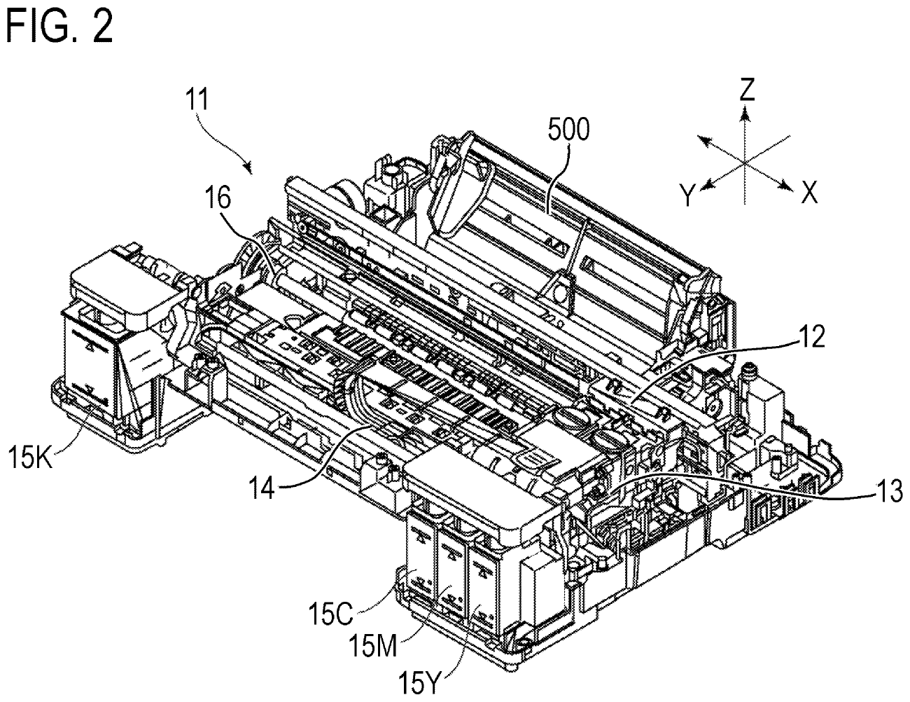

As shown in FIG. 1, the inkjet printer 11 includes a housing (exterior portion) 20, a head 13 (see FIG. 2) that performs a recording operation on the recording medium (not shown), and an ink tank 15 serving as an ink supply container that stores the ink supplied to the head 13. In the present embodiment, the ink tank 15 is disposed on a front side of the housing 20 (a +Y direction) and is fixed to the inkjet printer 11. In addition, an upper portion of the housing 20 is provided with a scanner unit 17 that performs a document reading operation, and an operation input portion 18 that allows a user to perform an operation such as command input.

FIG. 2 is a perspective view showing an internal configuration of the inkjet printer 11. The inkjet printer 11 includes a feeding portion 500 that feeds the recording medium, a conveying roller 16 that conveys the recording medium, and a discharge portion 40 (see FIG. 1) that discharges the recording medium. The recording medium is fed from the feeding portion 500 to the inside of the inkjet printer 11 by rollers (not shown). The fed recording medium is conveyed by the conveying roller 16 while the recording operation is performed by the head 13. The recording medium on which recording has been completed is discharged from the discharge portion 40 to the outside of the inkjet printer 11. The direction in which the recording medium is conveyed (Y direction) is referred to as the conveying direction. A carriage 12 is moved by a drive source (not shown) in the main scanning direction (X direction) that intersects the conveying direction of the recording medium. In the present embodiment, the conveying direction and the main scanning direction are orthogonal to each other.

The head 13 is mounted on the carriage 12, and discharges ink droplets while moving in the main scanning direction to perform the recording operation to record one band of image on the recording medium. When the one band of image has been recorded on the recording medium, the recording medium is conveyed in the conveying direction by a predetermined amount by the conveying roller 16 (an intermittent conveying operation). By repeating the recording operation for one band and the intermittent conveying operation, the image is recorded on the entire recording medium. Further, the inkjet printer 11 is provided with a maintenance unit that performs maintenance of the head 13 within a moving region of the carriage 12 in the main scanning direction.

The inkjet printer 11 has ink tanks that store ink used for recording for each ink color. In the present embodiment, the inkjet printer 11 includes a black ink tank 15K for black ink, a cyan ink tank 15C for cyan ink, a magenta ink tank 15M for magenta ink, and a yellow ink tank 15Y for yellow ink. In the following, when description can be made without distinguishing the ink colors, that is, when a common configuration will be described regardless of the ink colors, they may be simply referred to as the ink tank 15 with suffixes Y, M, C, and K indicating the ink colors omitted. The black ink tank 15K is provided on a left side of the discharge portion 40 when viewed from the front side (+Y direction side) with respect to the inkjet printer 11. On the other hand, the ink tanks for color ink (the cyan ink tank 15C, the magenta ink tank 15M, and the yellow ink tank 15Y) are provided on a right side of the discharge portion 40 when viewed from the front side of the inkjet printer 11. The discharge portion 40 is provided between the black ink tank 15K and the ink tank for color ink.

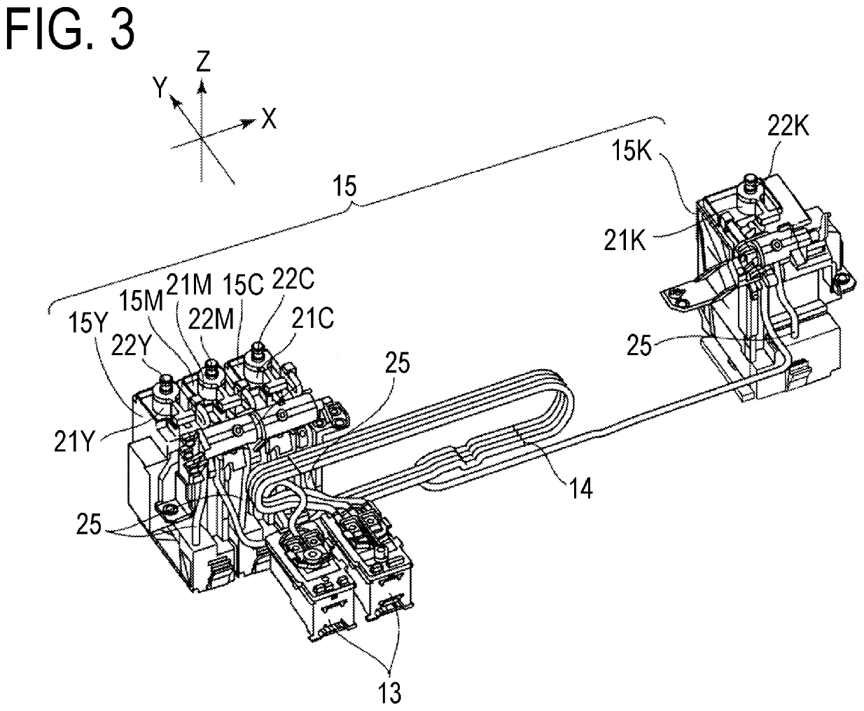

FIG. 3 is a perspective view showing an ink supply system of the inkjet printer 11. FIG. 3 is a diagram of the inkjet printer 11 when viewed from its rear side (−Y direction side). The ink tank 15 is provided for each ink color. A flexible tube forming an ink supply path 14 (ink flow path) for supplying the ink to the head 13 is attached to the ink tank 15. Also, a flexible tube forming an atmosphere communication path 25 for allowing communication between the inside of the ink tank 15 with the atmosphere is attached to the ink tank 15.

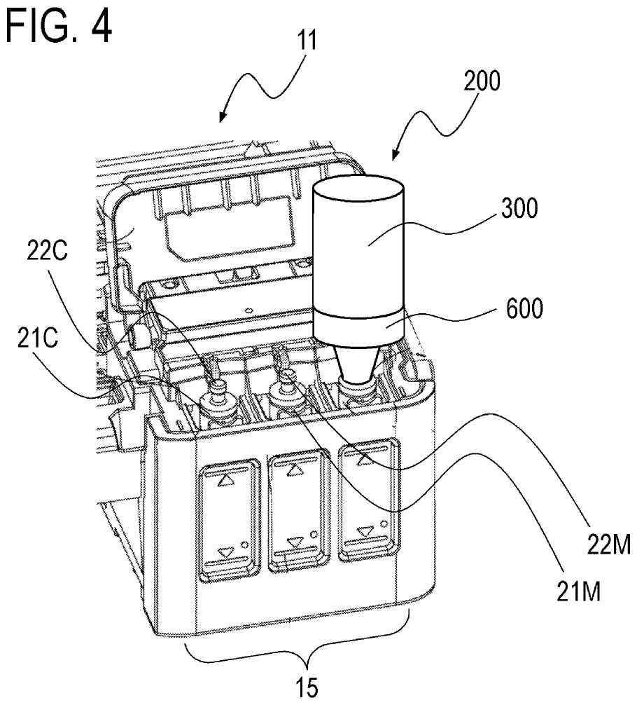

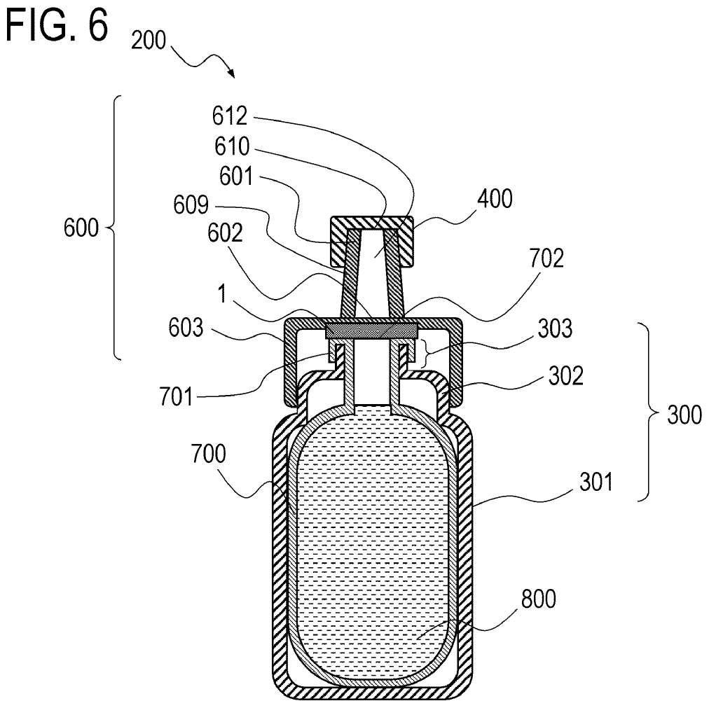

FIG. 4 is a perspective view showing a state in which ink 800 (see FIG. 6) is supplied from an ink supply container 200 (ink bottle) to the ink tank 15 of the inkjet printer 11. An upper portion of the ink tank 15 is provided with an injection port 21 for a user to inject the ink into the ink tank 15. In addition, a cap 22 (tank cap) for sealing the injection port 21 is detachably attached to the injection port 21. The user can inject the ink from the ink supply container 200 into the ink tank 15 by removing the cap 22 and connecting a nozzle 600 of the ink supply container 200 to the injection port 21.

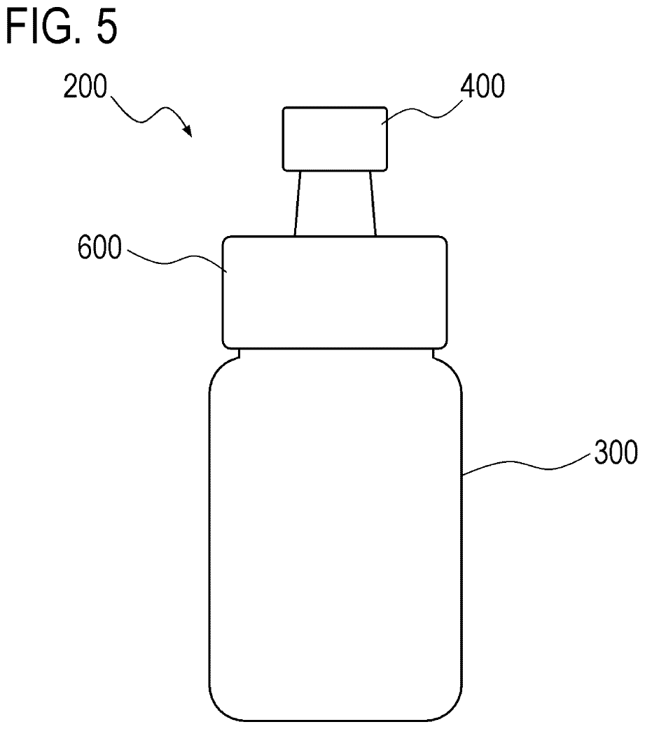

FIG. 5 is a front view of the ink supply container 200 in its upright state. The upright state is a state in which a bottom portion of the ink supply container 200 is placed on a horizontal plane. The ink supply container 200 has a container body 300, the nozzle 600, and a cap 400. The ink is stored in the container body 300. By connecting a tip portion of the nozzle 600 to the injection port 21 of the ink tank 15, the ink in the container body 300 is injected into the ink tank 15 through the nozzle 600. Thus, the ink can be supplied from the ink supply container 200 to the ink tank 15. The cap 400 is attachable to and detachable from the tip portion of the nozzle 600, attached to the nozzle 600 to seal an opening of the nozzle 600, and removed from the nozzle 600 to open the nozzle 600.

FIG. 6 is a cross-sectional view showing an internal configuration of the ink supply container 200. The container body 300 has a cylindrical portion 301, a shoulder portion 302, and a neck portion 303 in order from the bottom in the upright state. The cylindrical portion 301 is a bottomed cylindrical shape, and an extending direction of the cylindrical shape is referred to as an axial direction of the container body 300 and the ink supply container 200, and a direction perpendicular to the axial direction is referred to as a radial direction. The axial direction is parallel to the vertical direction in the upright state. A shape of the bottom portion can be circular, rectangular, polygonal, or the like, and is not particularly limited. The shoulder portion 302 having an inner diameter and an outer diameter smaller than those of the cylindrical portion 301 is provided on a side opposite to the bottom portion of the cylindrical portion 301. The neck portion 303 having an inner diameter and an outer diameter smaller than those of the shoulder portion 302 is provided on a side of the shoulder portion 302 opposite to the cylindrical portion 301. An opening through which the ink in the container body 300 can flow to the outside is provided on a side of the neck portion 303 opposite to the shoulder portion 302.

An ink bag 700 is accommodated in the container body 300. The ink bag 700 is a bag-shaped ink storing member that can store the ink 800. The ink bag 700 has a spout 702 through which the stored ink 800 can be injected. The ink bag 700 has a size that can be accommodated in the container body 300. The container body 300 can accommodate the ink bag 700 in a state in which the ink can be injected through the spout 702.

FIG. 6 shows a state in which the ink 800 is stored inside the ink bag 700. The ink bag 700 is made of an elastic material. Examples of the elastic material may include, for example, a material containing at least one of butyl rubber, ethylene propylene rubber, silicone rubber, and thermoplastic elastomer. An opening end 701 of the ink bag 700 extends outward in the radial direction, is folded back downward in the axial direction, and is fixed to the neck portion 303 of the container body 300 by a radially inward elastic force generated by elastic deformation of the ink bag 700 itself. Also, a configuration in which a seal member having an opening is inserted into the neck portion 303 and the ink bag 700 is sandwiched between an outer circumferential surface of the seal member and an inner circumferential surface of the neck portion 303 may be used. In this way, the ink bag 700 can be fixed more reliably.

When an amount of the ink 800 inside the ink bag 700 decreases, the ink bag 700 shrinks as a whole and becomes separable from the container body 300. When the ink bag 700 is separated from the container body 300, a part to which the ink 800 sticks is separated from the container body 300, and thus the container body 300 has no member to which the ink 800 sticks. Accordingly, the remaining container body 300 can be reused. In the case of reusing the container body 300, a new ink bag 700 is accommodated in the container body 300, and a new ink 800 is stored inside the new ink bag 700.

The nozzle 600 is attachable to and detachable from the container body 300. The nozzle 600 has a communication portion 602, a container attachment portion 603, a cap attachment portion 609, and a filter 1. The cap 400 is detachably provided on the cap attachment portion 609. A tip portion 601 of the cap attachment portion 609 has an opening portion 610 through which the ink can flow out, and has a shape that can be connected to the injection port 21 of the ink tank 15. An ink flow path 612 through which the ink can flow is formed inside the cap attachment portion 609. The ink flow path 612 communicates with the spout 702 via the communication portion 602 with the nozzle 600 attached to the container body 300. The ink in the container body 300 flows to the tip portion 601 of the nozzle 600 via the spout 702 and the communication portion 602.

The filter 1 is a filter member that is fixed to the communication portion 602 and can capture foreign matter if the foreign matter is present in the ink 800 flowing through the spout 702 into the ink flow path 612. The container attachment portion 603 is attachable to and detachable from the shoulder portion 302 of the container body 300. The nozzle 600 is attached to the container body 300 by fixing the container attachment portion 603 to the shoulder portion 302, and the nozzle 600 is removed from the container body 300 by removing the container attachment portion 603 from the shoulder portion 302.

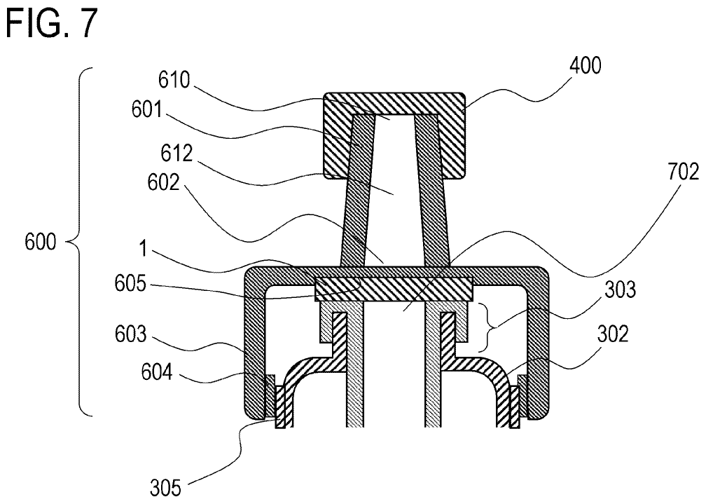

FIG. 7 is an enlarged view of the vicinity of the nozzle 600 in FIG. 6. A helical male thread 604 is provided on an inner circumferential surface of the container attachment portion 603 of the nozzle 600, and a helical female thread 305 is provided on an outer circumferential surface of the shoulder portion 302 of the container body 300. By rotating the nozzle 600 relative to the container body 300 in a first direction and screwing it thereinto with the male thread 604 and the female thread 305 engaged with each other, the nozzle 600 can be attached to the container body 300 by screwing. In addition, by rotating the nozzle 600 relative to the container body 300 in a second direction opposite to the first direction with the male thread 604 and the female thread 305 engaged with each other, the nozzle 600 can be removed from the container body 300. Also, a mechanism for attaching and detaching the nozzle 600 to and from the container body 300 is not limited to the above-mentioned screwing mechanism, and may be, for example, an engaging mechanism between an engaging portion and an engaged portion or a fitting mechanism between a fitting portion and a fitted portion.

A recessed portion 605 is provided on a surface of the communication portion 602 of the nozzle 600 on the container body 300 side. A shape of the recessed portion 605 is approximately the same as that of the filter 1, and the filter 1 can be fitted into the recessed portion 605. By heating an outer circumferential portion of the filter 1 with the filter 1 fitted into the recessed portion 605 and performing thermal welding of the filter 1 to the communication portion 602, the filter 1 can be fixed to the communication portion 602. Also, a method for fixing the filter 1 is not limited to thermal welding. For example, the filter 1 may be fixed to the communication portion 602 by applying an adhesive to the outer circumferential portion of the filter 1. Further, it may be fixed by making an outer shape dimension of the filter 1 greater than an inner diameter dimension of the recessed portion 605 and pressing the filter 1 into the recessed portion 605.

In a state in which the nozzle 600 is attached to the container body 300, the communication portion 602 of the nozzle 600 is pressed against the spout 702, the filter 1 is sandwiched and fixed between them, and a space between the communication portion 602 and the spout 702 is sealed.

A shape of the filter 1 may be a columnar shape having a thickness in the axial direction of the ink supply container 200. With such a shape, the filter 1 can be easily attached to the communication portion 602, and crush of the filter 1 can be inhibited when the communication portion 602 of the nozzle 600 is pressed against the spout 702 of the container body 300. In addition, the outer shape dimension of the filter 1 (its dimension in a virtual plane perpendicular to the axial direction) is greater than an outer shape dimension of the spout 702. That is, a position and a dimension of the filter 1 are configured so that, when the nozzle 600 in which the filter 1 is fixed to the recessed portion 605 is attached to the shoulder portion 302 of the container body 300, a projection of the filter 1 in the axial direction covers a projection of the spout 702 in the axial direction. Thus, leakage of the ink 800 in the communication portion 602 can be inhibited.

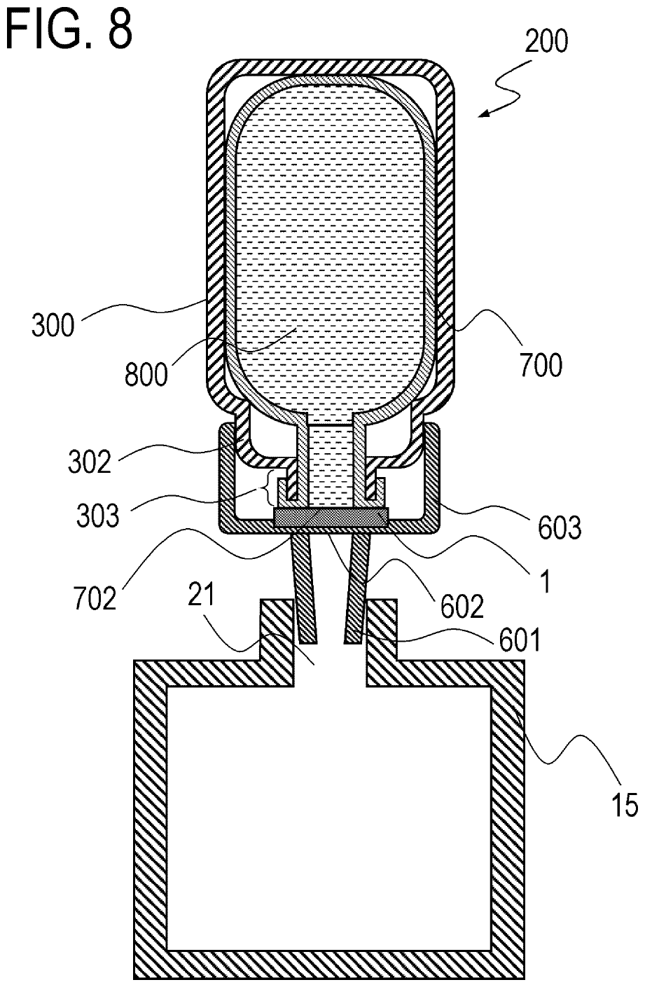

FIG. 8 is a cross-sectional view showing a state in which the ink supply container 200 is connected to the ink tank 15 in order to supply the ink 800 from the ink supply container 200 to the ink tank 15 of the inkjet printer 11. As shown in FIG. 8, by inserting the tip portion 601 of the nozzle 600 into the injection port 21, the ink can be supplied to the ink tank 15.

### Reuse of Ink Supply Container

In the case of reusing the container body 300 of a used ink supply container 200 and remanufacturing the ink supply container 200, the nozzle 600 is removed from the container body 300 of the used ink supply container 200, and the ink bag 700 is separated and removed from the container body 300. Then, a new ink bag 700 is attached to the container body 300, the new ink bag 700 is filled with the ink 800, and a new nozzle 600 is attached to the container body 300. That is, the nozzle 600 and the ink bag 700, to which the ink is being stuck, in the ink supply container 200 are discarded. The filter 1 fixed to the nozzle 600 is also discarded together with the nozzle 600. The container body 300 to which the ink does not stick can be reused. The cap 400 can also be reused if the ink does not stick thereto.

When the new ink bag 700 is filled with the ink 800, foreign matter may be mixed into the ink 800. Also, if the ink bag 700 made of an elastic material is broken, fragments thereof may become foreign matter in the ink 800.

According to the ink supply container 200 of the present embodiment, the filter 1 is provided in the communication portion 602. Accordingly, even if foreign matter is present in the ink 800 in the ink bag 700, the foreign matter is captured by the filter 1 when the ink 800 is supplied from the ink supply container 200 to the ink tank 15. Accordingly, clogging of the nozzle 600 or the ink flow path 612 due to the foreign matter, or clogging of the head 13 due to the foreign matter entering the ink tank 15 and reaching the head 13 can be inhibited.

### Embodiment 2

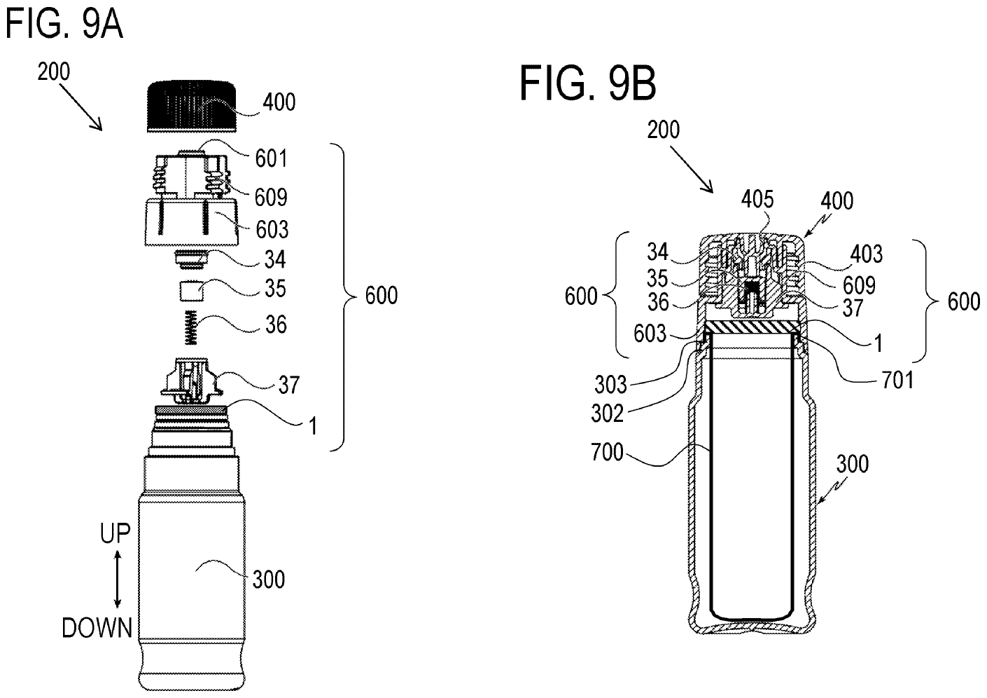

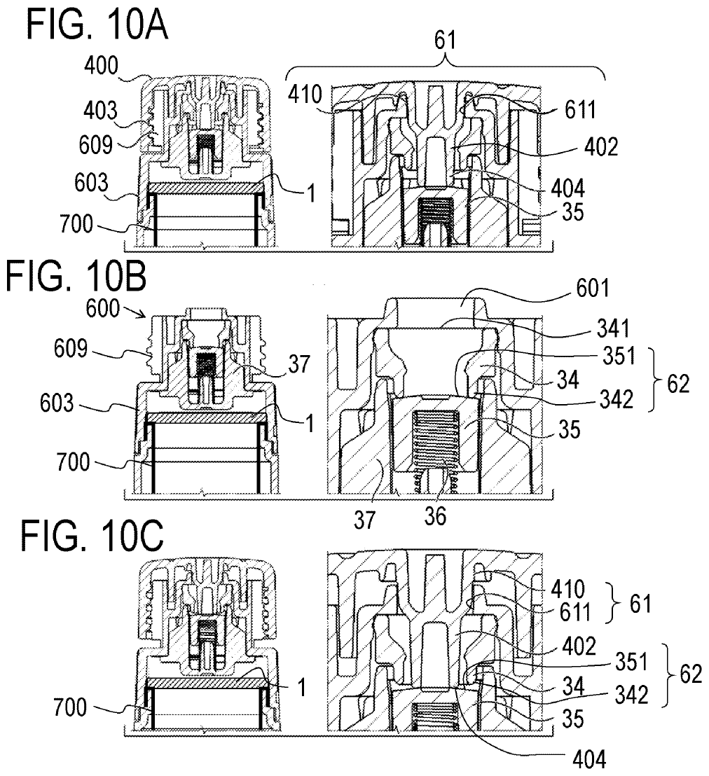

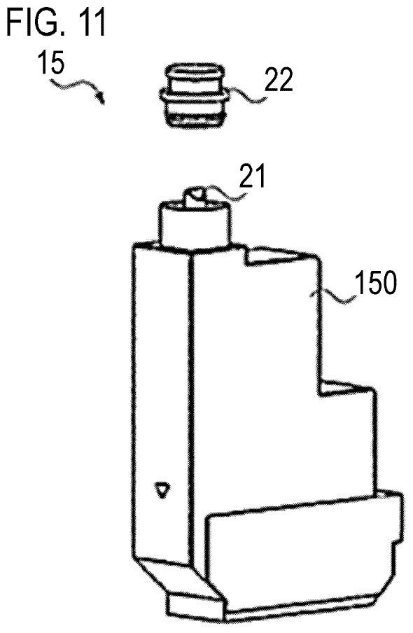

FIGS. 9A and 9B are diagrams showing a detailed structure of the ink supply container 200 of Embodiment 2. FIG. 9A is an exploded view showing components forming the ink supply container 200. FIG. 9B is a cross-sectional view of the ink supply container 200. FIGS. 10A to 10C are cross-sectional views showing a sealing structure of the ink supply container 200. FIG. 11 is a perspective view of the ink tank 15.

The ink supply container 200 has the container body 300, the ink bag 700, the nozzle 600, and the cap 400. The opening end 701 of the ink bag 700 is fixed to the neck portion 303 of the container body 300. The filter 1 is fixed to the nozzle 600. The nozzle 600 is attachable to and detachable from the shoulder portion 302 of the container body 300. In addition, the cap 400 that can seal the opening of the tip portion 601 is attachable to and detachable from the nozzle 600. With the nozzle 600 attached to the container body 300, the filter 1 is in close contact with the spout 702.

Inside the nozzle 600 of the ink supply container 200, a seal 34 having an opening, a valve body 35 that opens and closes the opening of the seal 34, a spring 36 that biases the valve body 35 in a valve closing direction, a holder 37 that holds the spring 36, and the filter 1 are provided. The filter 1 is configured to be able to capture foreign matter when the foreign matter is mixed into the ink in the ink supply container 200.

When the ink is supplied from the ink supply container 200 to the ink tank 15, the tip portion of the nozzle 600 of the ink supply container 200 is connected to the injection port 21 of the ink tank 15.

A recessed portion is provided in the vicinity of the tip portion 601 of the nozzle 600, and a protruding portion is provided in the vicinity of the injection port 21 of the ink tank 15, and these recessed portion and protruding portion are configured to be engageable with each other. By engaging the recessed portion of the ink supply container 200 with the protruding portion of the ink tank 15, the ink supply container 200 can be easily positioned when the tip portion 601 of the nozzle 600 is connected to the injection port 21 of the ink tank 15.

When the injection port 21 of the ink tank 15 is connected to the tip portion 601 of the nozzle 600 of the ink supply container 200, the ink in the ink supply container 200 flows into a tank body 150 of the ink tank 15 via the injection port 21 due to a water head difference. In this case, even if foreign matter is mixed into the ink, the foreign matter is captured by the filter 1, and thus entrance of the foreign matter into the ink tank 15 via the injection port 21 can be prevented.

### Sealing Structure of Ink Supply Container

The ink supply container 200 has a first sealing structure 61 and a second sealing structure 62 that can seal between the inside and outside of the ink supply container 200. As shown in FIG. 10A, the first sealing structure 61 is sealed by fitting of the cap 400 to the nozzle 600. As shown in FIG. 10B, the second sealing structure 62 is sealed by a valve structure in the nozzle 600. The sealing structures will be described below.

A left diagram of FIG. 10A is a cross-sectional view of an upper portion of the ink supply container 200 with the cap 400 attached to the nozzle 600, and a right diagram of FIG. 10A is an enlarged view thereof. By attaching the cap 400 to the nozzle 600, a cap seal portion 410 of the cap 400 and a nozzle seal portion 611, which is a part of the tip portion 601 of the nozzle 600, are fitted together to form the first sealing structure 61. The cap 400 is provided with a protrusion 402 extending downward from its upper portion, and the cap seal portion 410 is a part of a side surface of the protrusion 402. The tip portion 601 of the nozzle 600 has an opening through which the protrusion 402 can be inserted, and the nozzle seal portion 611 is a part of an inner circumferential surface of the opening.

As a structure for attaching the cap 400 to the nozzle 600, a threaded structure can be exemplified. As shown in FIGS. 9A and 9B and FIG. 10A, a male thread is formed on an outer circumferential surface of the cap attachment portion 609 of the nozzle 600. The cap 400 has an upper surface 405 and a cylindrical portion 403, and a female thread is formed on an inner circumferential surface of the cylindrical portion 403. By screwing these male and female threads and fixing the cap 400 to the cap attachment portion 609 of the nozzle 600, the nozzle seal portion 611 and the cap seal portion 410 are brought into close contact with each other. An annular gap between the tip portion 601 and the protrusion 402 is sealed to form the first sealing structure 61.

Also, a male thread may be formed on the inner circumferential surface of the cylindrical portion 403 of the cap 400, and a female thread may be formed on the outer circumferential surface of the cap attachment portion 609 of the nozzle 600. In addition, the structure for attaching the cap 400 to the nozzle 600 is not limited to the above-mentioned threaded structure. For example, a fitting structure for attaching and detaching the cap 400 to and from the nozzle 600 may be provided separately from the first sealing structure 61. For example, a fitting structure between the inner circumferential surface of the cap 400 and the outer circumferential surface of the nozzle 600 or a fitting structure (inner lid structure) between the outer circumferential surface of the cap 400 and the inner circumferential surface of the nozzle 600 may be used.

A left diagram of FIG. 10B is a cross-sectional view of the upper portion of the ink supply container 200 without the cap 400 attached to the nozzle 600, and a right diagram of FIG. 10B is an enlarged view thereof.

The second sealing structure 62 is configured of a liquid stop valve structure provided inside the nozzle 600 of the ink supply container 200. As shown in FIG. 10B, the seal 34, which is an orifice portion having an opening 341 into which the injection port 21 of the ink tank 15 can be inserted, is provided at the tip portion 601 of the nozzle 600. A valve body 35 of the liquid stop valve is biased toward the seal 34 by a spring 36. Thus, a lower end portion 342 of the seal 34 and an upper surface 351 of the valve body 35 are brought into close contact with each other, and the opening 341 of the seal 34 is closed to seal the container body 300.

The nozzle 600 has a shape in which a plurality of cylindrical portions having different inner diameters are connected to each other, and is provided with the holder 37 that holds the spring 36 at a position below the tip portion 601 in its internal space. The seal 34 is made of a flexible material such as a rubber or elastomer.

The second sealing structure 62 configured by the liquid stop valve structure can keep the inside of the container body 300 sealed even when the cap 400 is not attached to the nozzle 600 as shown in FIG. 10B.

When the ink is supplied to the ink tank 15 from the ink supply container 200, the injection port 21 of the ink tank 15 is inserted into the opening 341 of the seal 34 from the tip portion 601 of the nozzle 600 of the ink supply container 200. Thus, a tip of the injection port 21 presses the upper surface 351 of the valve body 35 downward, and the valve body 35 moves downward against a biasing force of the spring 36, whereby the close contact between the upper surface 351 of the valve body 35 and the lower end portion 342 of the seal 34 is released, and the second sealing structure 62 is open. Thus, since the opening 341 and the container body 300 are in a state in which a liquid can flow therethrough, the ink in the container body 300 flows into the tank body 150 via the injection port 21 due to the water head difference.

### Simultaneous Opening of Two Sealing Structures

In the ink supply container 200 of the present embodiment, there are timings for both the first sealing structure 61 and the second sealing structure 62 being in open states when the cap 400 is removed from the nozzle 600 and when the cap 400 is attached to the nozzle 600. When both the first sealing structure 61 and the second sealing structure 62 are in the open states, the inside of the container body 300 (ink bag 700) communicates with the atmosphere, and a pressure in the container body 300 (ink bag 700) becomes equal to the atmospheric pressure. This will be described in detail below.

First, when the cap 400 is attached to the nozzle 600, the first sealing structure 61 is in a sealed state as shown in FIG. 10A. When the cap 400 is attached to the nozzle 600, a lower end portion 404 of the protrusion 402 is configured to be located below the lower end portion 342 of the seal 34 in the axial direction. Thus, when the cap 400 is attached to the nozzle 600, the protrusion 402 presses the valve body 35 downward from a valve closing position, a gap is formed between the seal 34 and the valve body 35, and the second sealing structure 62 is in the open state. That is, when the cap 400 shown in FIG. 10A is attached to the nozzle 600, the first sealing structure 61 is sealed and the second sealing structure 62 is open.

A left diagram of FIG. 10C is a cross-sectional view of the upper portion of the ink supply container 200 when the cap 400 shown in FIG. 10A starts to be removed from the state in which the cap 400 is attached to the nozzle 600, and a right diagram of FIG. 10C is an enlarged view thereof. When the cap 400 starts to be removed from the nozzle 600, the cap 400 moves upward. With the movement of the cap 400, the fitting of the cap seal portion 410 to the nozzle seal portion 611 is released, and the first sealing structure 61 is open. In this case, as shown in FIG. 10C, a position of the lower end portion 404 of the protrusion 402 of the cap 400 is still below a position of the lower end portion 342 of the seal 34 and at a position at which the valve body 35 is pushed downward from the valve closing position. Accordingly, the second sealing structure 62 maintains the open state. In this case, both the first sealing structure 61 and the second sealing structure 62 are in the open states.

After that, when the cap 400 is further moved upward, the position of the lower end portion 404 of the protrusion 402 is located above the position of the lower end portion 342 of the seal 34, and the protrusion 402 is separated from the valve body 35. In this case, the valve body 35 and the seal 34 are brought into close contact with each other by the urging force of the spring 36, and the second sealing structure 62 is in a sealed state. The first sealing structure 61 is in the open state.

When the cap 400 is not attached to the nozzle 600, the first sealing structure 61 is in the open state, and the second sealing structure 62 is in the sealed state. When the cap 400 starts to be attached to the nozzle 600, the cap 400 moves downward. Before the cap seal portion 410 reaches a position at which it fits into the nozzle seal portion 611, the lower end portion 404 of the protrusion 402 of the cap 400 comes into contact with the upper surface 351 of the valve body 35. A length of the protrusion 402, a position at which the valve body 35 is held by the holder 37, and positions of the cap seal portion 410 and the nozzle seal portion 611 are set in that way. Thus, before the first sealing structure 61 is in the sealed state, the valve body 35 is pushed by the protrusion 402, and the second sealing structure 62 is in the open state. That is, both the first and second sealing structures 61 and 62 are in the open states. When the cap 400 is further moved downward, the cap seal portion 410 reaches a position at which it fits into the nozzle seal portion 611, and the first sealing structure 61 is in the sealed state. The second sealing structure 62 is in the open state.

In this way, when the cap 400 is attached to and detached from the nozzle 600, there are the timings for both the first and second sealing structures 61 and 62 being in the open states. For that reason, the inside of the container body 300 (ink bag 700) communicates with the atmosphere at that timings, and an internal pressure of the container body 300 (ink bag 700) becomes equal to the atmospheric pressure. Thus, when the cap 400 is removed from the nozzle 600 and the ink is supplied from the ink supply container 200 to the ink tank 15, blowout of the ink due to an increase in the internal pressure of the container body 300 can be inhibited. Also, overflow of the ink from the tank body 150 can be inhibited. In addition, since the second sealing structure 62 maintains the container body 300 in the sealed state while the cap 400 has been removed from the nozzle 600, leakage of ink can be inhibited even if the ink supply container 200 falls down from the upright state.

Various examples of the filter 1 will be described below.

### Example 1

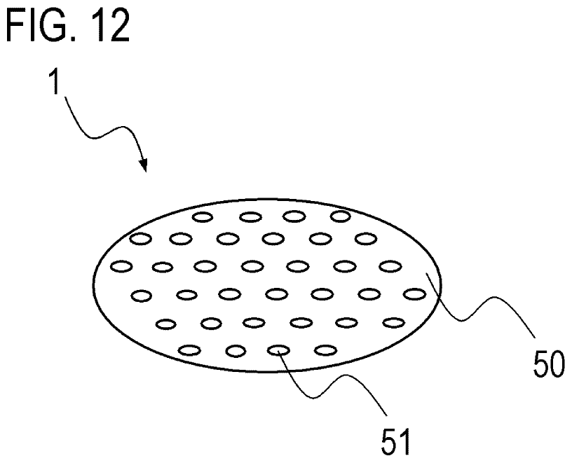

FIG. 12 is a perspective view showing a structure of the filter 1 of Example 1. The filter 1 of Example 1 has a flat plate-shaped substrate 50 and a plurality of openings 51 provided in the substrate 50. The substrate 50 is a plate-shaped member. The opening 51 is a hole having a dimension that allows the ink 800 to flow therethrough and can capture foreign matter in the ink 800 without allowing it to flow through. An inner diameter of the opening 51 may be, for example, at least 0.5 mm and not more than 1 mm, but is not limited thereto. In Example 1, the substrate 50 is provided with a plurality of circular openings 51 with a diameter of 1 mm or less. The plurality of openings 51 are disposed at equal intervals in two mutually intersecting directions parallel to a surface of the substrate 50. Also, shapes of the openings 51 are not limited to circular shapes. Arrangement of the plurality of openings 51 is not limited to the above example. The filter 1 is fixed to the communication portion 602 by thermal welding. Also, as described above, a fixing method of the filter 1 is not limited to thermal welding. An appropriate fixing method can be adopted depending on a material of the substrate 50 of the filter 1, a material of the communication portion 602 of the nozzle 600, or the like.

Since large fragments of sizes equal to or greater than inner diameters of the openings 51 and foreign matter in the ink 800 generated when the ink bag 700 accommodated in the container body 300 is broken cannot pass through the openings 51, their entrance to the ink flow path 612 side from the substrate 50 can be inhibited. Accordingly, foreign matter in the container body 300 can be captured by the filter 1, and clogging of the ink flow path 612 with the foreign matter and entrance of the foreign matter into the ink tank 15 can be inhibited.

Examples of a material of the filter 1 may include a resin and SUS. Examples of a manufacturing method of the filter 1 may include injection molding using a resin material and cutting processing of an SUS material.

### Example 2

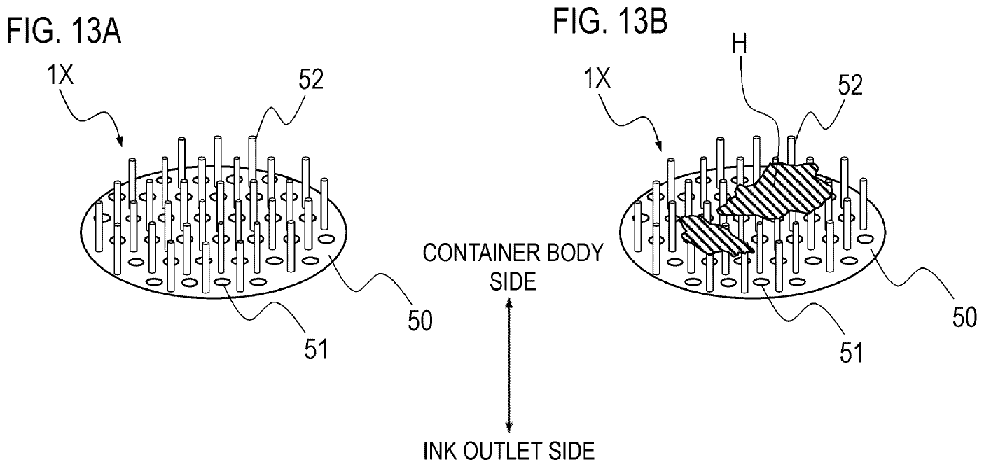

FIGS. 13A and 13B and perspective views showing a structure of a filter 1X of Example 2. The filter 1X of Example 2 has the substrate 50, the plurality of openings 51 provided in the substrate 50, and protrusion portions 52 protruding from the substrate 50 toward the container body 300 in the axial direction. The protrusion portions 52 extend in a direction toward the container body 300 with the nozzle 600 attached to the container body 300. The substrate 50 and the openings 51 are similar to those in Example 1. The plurality of protrusion portions 52 are provided at positions different from the plurality of openings 51 in a surface of the substrate 50. In Example 2, the plurality of protrusion portions 52 are provided between the plurality of openings 51. Accordingly, similarly to the plurality of openings 51, the plurality of protrusion portions 52 are disposed at equal intervals in the two mutually intersecting directions parallel to the surface of the substrate 50. The protrusion portions 52 are fixed to the substrate 50 by thermal welding toward the container body side. A fixing method of the protrusion portions 52 to the substrate 50 is not limited to thermal welding. An appropriate fixing method can be adopted depending on a material of the substrate 50, materials of the protrusion portions 52, or the like. The filter 1X is fixed to the communication portion 602 by thermal welding. Also, as described above, a fixing method of the filter 1X is not limited to thermal welding. An appropriate fixing method can be adopted depending on the material of the substrate 50 of the filter 1X, the material of the communication portion 602 of the nozzle 600, or the like.

As shown in FIG. 12B, large fragments H of sizes equal to or greater than the intervals between the protrusion portions 52 generated when the ink bag 700 accommodated in the container body 300 is broken are caught by end portions of the plurality of protrusion portions 52 on the container body 300 side. For that reason, the fragments H are prevented from reaching the surface of the substrate 50 on which the openings 51 are formed. Accordingly, blocking of the openings 51 caused by the fragments H can be inhibited. Since foreign matter having a size equal to or greater than the inner diameters of the openings 51 that cannot be captured by the protrusion portions 52 cannot pass through the openings 51, entrance thereof to the ink flow path 612 side from the substrate 50 can be inhibited. Accordingly, foreign matter in the container body 300 can be captured by the filter 1X, and clogging of the ink flow path 612 with the foreign matter and entrance of the foreign matter into the ink tank 15 can be inhibited.

Examples of the material of the filter 1X may include a resin and SUS. Examples of a manufacturing method of the filter 1X may include injection molding using a resin material and cutting processing of an SUS material.

### Example 3

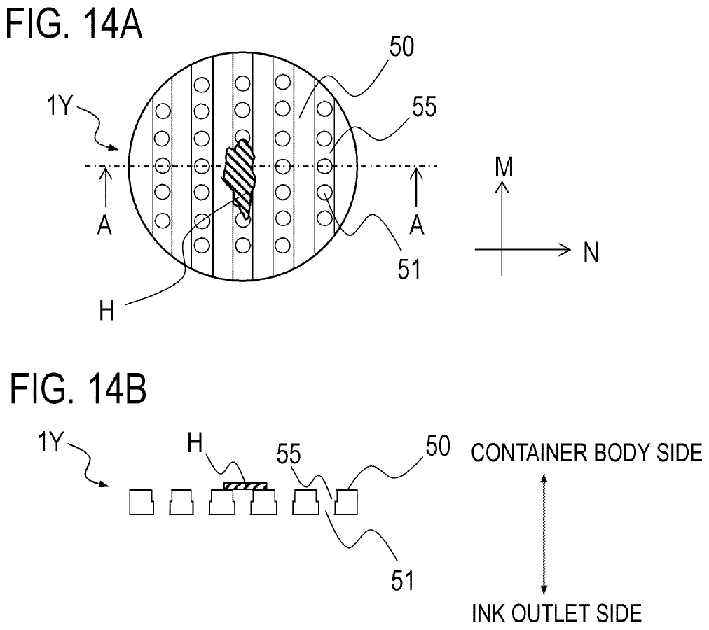

FIGS. 14A and 14B are diagrams showing a structure of a filter 1Y of Example 3. FIG. 14A is a plan view of the filter 1Y, and FIG. 14B is a diagram showing its cross-section along line A-A in FIG. 14A. The filter 1Y of Example 3 has the flat plate-shaped substrate 50, a plurality of recessed portions 55 provided on the surface of the substrate 50 on the container body 300 side, and a plurality of openings 51 provided at bottom portions of the recessed portions 55. The recessed portions 55 are provided on a surface of the substrate 50 facing the container body 300 with the nozzle 600 attached to the container body 300. The openings 51 are holes having dimensions that allow the ink 800 to flow therethrough and can capture foreign matter in the ink 800 without allowing it to flow through. The recessed portions 55 have a linear shape extending parallel to the first direction (arrow M direction) parallel to the surface of the substrate 50. The recessed portions 55 are formed to extend from one end portion to the other end portion in the first direction of the substrate 50. The plurality of recessed portions 55 are provided at equal intervals in a second direction (arrow N direction) intersecting (orthogonal to) the first direction. A width of the bottom portion of the recessed portion 55 in the second direction is greater than an inner diameter of the opening 51. The plurality of openings 51 are provided at the bottom portions of the recessed portions 55 at equal intervals in the first direction.

As shown in FIG. 14A, even if the large fragments H are captured at positions at which the openings 51 are present in a plan view, the ink 800 can flow through the recessed portions 55 to the openings 51 below the fragments H unless the entire recessed portions 55 are closed. Accordingly, blocking of the openings 51 caused by the fragments H can be inhibited. The filter 1Y is fixed to the communication portion 602 by thermal welding with the surface of the substrate 50, on which the recessed portions 55 are provided, facing the container body 300 side. Also, as described above, a fixing method of the filter 1Y is not limited to thermal welding. An appropriate fixing method can be adopted depending on the material of the substrate 50 of the filter 1Y, the material of the communication portion 602 of the nozzle 600, or the like.

The large fragments H generated when the ink bag 700 accommodated in the container body 300 is broken are captured by the surface of the substrate 50 without entering the recessed portions 55. Since foreign matter having a size equal to or greater than the inner diameters of the openings 51 entering the recessed portions 55 cannot pass through the openings 51, entrance thereof to the ink flow path 612 side from the substrate 50 can be inhibited. Accordingly, foreign matter in the container body 300 can be captured by the filter 1Y, and clogging of the ink flow path 612 with the foreign matter and entrance of the foreign matter into the ink tank 15 can be inhibited.

Examples of a material of the filter 1Y may include a resin and SUS. Examples of a manufacturing method of the filter 1Y may include injection molding using a resin material and cutting processing of an SUS material.

### Example 4

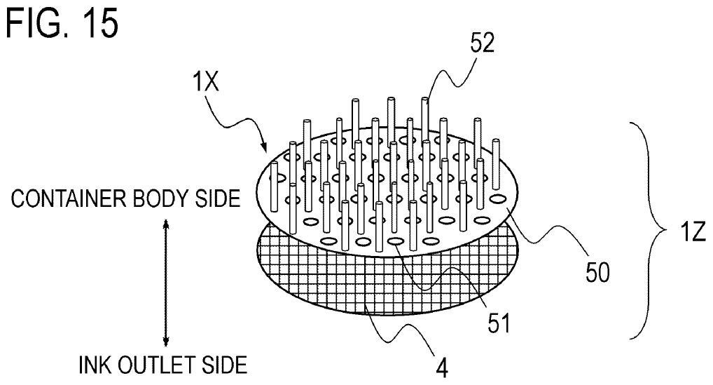

FIG. 15 is a perspective view showing a structure of a filter member 1Z of Example 4. The filter member 1Z of Example 4 has a two-layer structure configured of a first filter and a second filter located on a side farther from the container body 300 (a side closer to the ink flow path 612) than the first filter when the nozzle 600 is attached to the container body 300. The filter member 1Z has the filter 1X shown in Example 2 as the first filter (a layer on the container body 300 side), and a mesh-like filter 4 as the second filter (a layer on the ink flow path 612 side). The filter member 1Z is fixed to the communication portion 602 by thermal welding with the protrusion portions 52 of the first filter 1X facing the container body 300 side. Also, as described above, a fixing method of the filter member 1Z is not limited to thermal welding. An appropriate fixing method can be adopted depending on the material of the substrate 50 of the filter member 1Z, the material of the communication portion 602 of the nozzle 600, or the like.

The first filter 1X can capture the large fragments generated when the ink bag 700 accommodated in the container body 300 is broken. Since foreign matter having a size equal to or greater than the inner diameters of the openings 51 that cannot be captured by the protrusion portions 52 cannot pass through the openings 51, entrance thereof to the ink flow path 612 side from the substrate 50 can be inhibited. Foreign matter greater than a mesh of the second filter 4 included in the foreign matter that has passed through the openings 51 can be captured by the second filter 4. The opening 51 of the first filter 1X may be a circular hole with a diameter of 1 mm or less, and the second filter 4 may be a mesh having a mesh size smaller than 1 mm. Also, sizes of the openings 51 and the mesh are not limited to these sizes. According to the filter member 1Z of Example 4, foreign matter in the container body 300 can be captured, and clogging of the ink flow path 612 with the foreign matter and entrance of foreign matter into the ink tank 15 can be inhibited.

Examples of a material of the filter 1X may include a resin and SUS. Examples of a material of the filter 4 may include SUS. Examples of a manufacturing method of the filter 1X may include injection molding using a resin material and cutting processing of an SUS material.

Also, in Example 4, the combination of the filter 1X of Example 2 and the mesh-like filter 4 has been exemplified, but a filter to be combined with the filter 4 may be the filter 1 of Example 1 and the filter 1Y of Example 3.

### Example 5

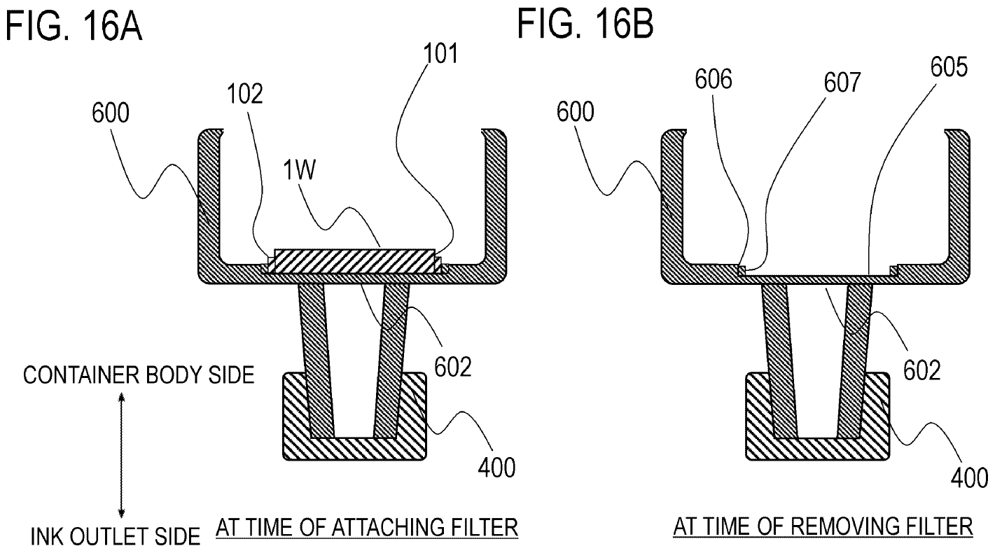

FIGS. 16A and 16B are cross-sectional views showing a structure of a filter 1W of Example 5. A helical male thread 102 is provided on an outer circumferential surface 101 of the filter 1W of Example 5. In addition, the recessed portion 605 is provided in the communication portion 602 of the nozzle 600, and a helical female thread 607 is provided on an inner circumferential surface 606 of the recessed portion 605. By rotating (for example, rotating clockwise) the filter 1W with the male thread 102 and the female thread 607 engaged with each other, the filter 1W is moved down into the recessed portion 605 of the communication portion 602. By rotating the filter 1W until it stops rotating, the filter 1W can be fixed to the recessed portion 605 of the communication portion 602 by screwing. In addition, by rotating the filter 1W in a direction opposite to that at the time of installation (for example, anticlockwise), the filter 1W is moved up from the recessed portion 605. Further, the filter 1W can be removed from the recessed portion 605 by rotating the filter 1W. In this way, the filter 1W of Example 5 is attachable to and detachable from the communication portion 602 of the nozzle 600 with a simple operation. After the ink supply container 200 is used up, the filter 1W is removed from the nozzle 600, washed, and then attached to the nozzle 600 again, and thus the filter 1W can be reused and waste can be reduced. In the ink supply container 200 of Example 5, the used nozzle 600 and ink bag 700 to which the ink is being stuck can be discarded, and the container body 300 to which no ink is stuck and the cleaned filter 1W can be reused.

According to the ink supply container 200 of the present disclosure described above, even if foreign matter is mixed into the ink in the container body 300 by reusing the container body 300, clogging of the ink flow path 612 of the ink supply container 200 can be inhibited. Also, even if the ink is supplied to the ink tank 15 of the inkjet printer 11 using the ink supply container 200 in which foreign matter has been mixed into the container body 300 by reusing the container body 300, clogging of the head 13 with the foreign matter can be inhibited. Accordingly, concerns about reuse of the container body 300 can be eliminated, and reuse can be promoted. In addition, an amount of waste can be reduced as compared with the case in which all of the used ink supply containers 200 are discarded, and reduction of waste can be promoted. For these reasons, the technologies described in this specification have the potential to contribute to the achievement of a sustainable society, such as a decarbonized society/circular society.

According to the present disclosure, even when foreign matter is mixed into the ink in the ink supply container, it is possible to inhibit occurrence of clogging of the head of the printer that has been supplied with the ink from the ink supply container or the nozzle of the ink supply container, thereby facilitating reuse of the ink supply container.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-078955, filed on May 14, 2024, which is hereby incorporated by reference herein in its entirety.

What is claimed is:

1. An ink supply container configured to supply ink to a recording apparatus that performs recording by discharging the ink to a recording medium, comprising:
a bag-shaped ink storing member configured to be able to store the ink, the ink storing member including a spout through which the stored ink is injectable;
a container body configured to be able to accommodate the ink storing member in a state in which the ink is injectable from the spout; and
a nozzle configured to be attachable to and detachable from the container body, the nozzle including an ink flow path that communicates with the spout in a state of being attached to the container body, and an opening portion that opens the ink flow path to the outside,
wherein the ink flow path is provided with a filter member configured to be able to capture foreign matter contained in the ink flowing in from the spout.

2. The ink supply container according to claim 1,
wherein the filter member includes a filter including a flat plate-shaped substrate and a plurality of openings provided in the substrate.

3. The ink supply container according to claim 2,
wherein the filter is provided with a plurality of protrusions provided between the plurality of openings in the substrate, and the plurality of protrusions protrude in a direction toward the container body in a state in which the nozzle is attached to the container body.

4. The ink supply container according to claim 1,
wherein the filter member includes a filter including a flat plate-shaped substrate, a plurality of recessed portions provided on a surface of the substrate facing the container body in a state in which the nozzle is attached to the container body, and a plurality of openings provided in bottom portions of each of the plurality of recessed portions.

5. The ink supply container according to claim 2,
wherein the filter member has a two-layer structure including a first filter and a second filter that is located on a side farther from the container body than the first filter in a state in which the nozzle is attached to the container body,
wherein the first filter is the filter, and
wherein the second filter is a mesh filter.

6. The ink supply container according to claim 2,
wherein the openings have a diameter of 1 mm or less.

7. The ink supply container according to claim 1,
wherein the filter member is attachable to and detachable from the nozzle.

8. The ink supply container according to claim 1,
wherein the ink storing member is made of an elastic material.

9. The ink supply container according to claim 8,
wherein the elastic material contains at least one of butyl rubber, ethylene propylene rubber, silicone rubber, and thermoplastic elastomer.

10. A method for remanufacturing the ink supply container according to claim 1, comprising:
removing the used nozzle and the ink storing member from the container body in the used ink supply container;
attaching a new ink storing member to the container body;
filling the new ink storing member with the ink; and
attaching a new nozzle to the container body.
